(19) United States
(12) Patent Application Publication
(10) Pub. No.: US 2007/0262658 A1
(43) Pub. Date: Nov. 15, 2007

(54) Magnetic Shield in the End Area of the Stator of a Three-Phase Generator

(76) Inventors: Oliver Drubel, Pegnitz (DE); Reinhard Joho, Rombach (SZ); Peter Arend, Rheinfelden (DE)

Correspondence Address: CERMAK KENEALY & VAIDYA LLP, 515 E. BRADDOCK RD, SUITE B, ALEXANDRIA, VA, 22314, US

(21) Appl. No.: 11/675,105

(22) Filed: Feb. 15, 2007

(30) Foreign Application Priority Data
Mar. 31, 2006 (CH) 00544/06

(51) Int. Cl. H02K 5/02; H02K 15/12

(52) U.S. Cl. 310/44; 29/596; 310/85

(57) ABSTRACT

A shield (2) for components on the stator (10) of a three-phase generator (1), with at least one pressure plate (3) or the like being arranged at the end on the stator core (6), is distinguished in that the shield (2) is composed essentially of a magnetically permeable composite material of low electrical conductivity. A method for production of a shield such as this includes the pressing and heat-treatment of appropriate composite particles. This overcomes the disadvantages of the prior art and provides a shield for components on the stator of a three-phase generator, which reduces the additional losses and prevents a build up of heat. Furthermore, this results in a solution which can be produced and installed easily and at low cost, and which can also easily be retrofitted to existing installations. Furthermore, three-dimensional finite element design methods can be used for optimized guidance of the magnetic field.

This application claims priority under 35 U.S.C. § 119 to Swiss application number no. 00544/06, filed 31 Mar. 2006, the entirety of which is incorporated by reference herein.

### BACKGROUND

1. Field of the Invention

The invention relates to a magnetic shield for components on a stator of a three-phase generator. A production method is also specified for a corresponding shield.

2. Brief Description of the Related Art

One major source of additional losses in three-phase generators occurs in the metallic structural parts in the end area of the stator. Parasitic magnetic fields, caused by currents in the end windings of the stator winding and rotor winding, produce eddy currents in these parts, which results in additional losses. These additional losses generally make up about 0.05% to 0.1% of the efficiency of a turbogenerator. A major aim in this field of technology is therefore to reduce these additional losses as much as possible. A further aim at the same time is to avoid heat building up, as likewise occurs in this area. Many of these losses are a result of three-dimensional field effects in the casing or pressure-plate regions. In this case, the magnetic flux enters the casing walls or the pressure plate.

Conventional shielding of high-energy magnetic fields or of electromagnetic waves is based on the induction of powerful eddy currents in metallic sheaths, whose fields counteract the inducing disturbance fields, so-called eddy-current shielding.

Eddy currents place a particular load on the pressure plate, which terminates the stator core and keeps it compressed axially. Furthermore, casing parts, in particular walls and ribs close to conductors, may also be at risk.

A detail of a conventional three-phase generator 1 according to the prior art is illustrated in the form of a section in FIG. 5. This shows, schematically, the rotor body 8, in which the rotor windings 7 are arranged. The rotor body 8 rotates in a stator core 6, which is terminated at the end by pressure plates 3 composed of solid metal, for example non-magnetic steel. The stator winding 11 is located in the stator core 6 and ends in a stator end winding in the end area. The known design results in stray fields in the end area, and these are illustrated in the figure by corresponding magnetic lines of force 9. These fields, in the case of the prior art, enter the pressure plates 3 and the casing walls 5 to a specific penetration depth, thus leading to eddy currents.

Eddy currents can cause considerable energy losses, the so-called eddy-current losses, in which energy is taken from the magnetic field and is converted to heat. In order to keep the losses low, electrically highly conductive metal plates (for example composed of copper) are arranged in front of the parts that are at risk, and the eddy currents can flow in these metal plates with low losses (flux diversion). Furthermore, in order to keep these losses low, conductive bodies are formed ferromagnetically and are subdivided as much as possible, for example by means of stepped structures composed of electrical laminates (flux suction).

US 2002/0079875 A1 discloses a generator which has apparatuses used for magnetic flux suction. The annular apparatuses for magnetic flux suction are arranged in the two end areas on the internal circumference of the stator. According to one embodiment, the apparatuses for magnetic flux suction may be produced from magnetically isotropic material, for example with a powder-iron composition, with the material having a high electrical resistance, being thermally conductive and having a high isotropic permeability. However, axial magnetic flux is in this case deflected only two-dimensionally.

### SUMMARY

One of numerous aspects of the present invention therefore to attempt to avoid the abovementioned disadvantages of the prior art. Another aspect of the present invention is based on the technical problem of providing shielding over an area for components on the stator of a three-phase generator, which reduces the additional losses and prevents a build up of heat. A further aspect includes providing a solution which can be produced and installed as easily and at as low a cost as possible, and which can also easily be retrofitted to existing installations. Another aspect includes allowing the use of three-dimensional finite element design methods for optimization of the magnetic field.

In another aspect of the present invention, in an exemplary shield for components on the stator of a three-phase generator, with at least one pressure plate or the like being arranged at the end on the stator, the shield is composed essentially of a magnetically permeable composite material of low electrical conductivity. In this case, the composite material has isotropic magnetic characteristics and is ideally suited for covering complex geometric structures.

In this case, the shield is advantageously fitted to areas close to the winding of the at least one pressure plate and/or of the casing.

This avoids disadvantages of the prior art, and provides a shield for casing components and/or casing bushings on a stator of a three-phase generator, which reduces the additional losses and prevents a build up of heat. Furthermore, a solution which can be produced and installed easily and at low cost is provided, which can also easily be retrofitted to existing installations. In addition, three-dimensional finite element design methods can be used for optimized guidance of the magnetic field.

According to yet another aspect of the present invention, a shield composed of a magnetically permeable composite material of low electrical conductivity is provided which, for example, can be used as a coating over the end pressure plates in front of the end windings. The flux suction and flux guidance which can be achieved in this way result in considerably smaller losses than the flux diversion already known from the prior art, in particular by means of aluminum or copper shields, since the magnetic field does not penetrate into electrically highly conductive material (pressure plates, shields), so that no eddy currents are generated. At the same time, the end scatter is increased by up to 50% by the use of highly permeable material, thus leading to a desired increase in the sub-transient reactance.

One advantageous aspect of the invention provides for the composite material (soft magnetic composite—SMC) to have magnetically permeable particles surrounded by an insulating layer. Composite particles such as these, which are essentially composed of iron powder with an insulating plastic sheath, are commercially available, for example under the names SOMALOY 500, SOMALOY 550 from Höganas AB, or under the name ACCUCORE from Magnetics International Inc. With the resultant 3D field guidance, the eddy-current losses when using SMCs such as these are considerably less than when using laminated sheets. The particle size is in this case a few micrometers, for example 100 μm.

In this case, one particularly advantageous aspect provides for the insulating layer on the composite particles to have a thickness of a few micrometers, preferably 20 μm to 40 μm, for example 30 μm. The electrically insulating layer is in this case produced, for example, by phosphating of the surface.

A further advantageous embodiment of the invention provides for the shield to have a carrier material in which the composite particles are held. One such carrier material may be a thermoplastic which connects the particles, such as Peracil® (Phenol-cresol formaldehyde) or Ultem® (polyetherimide). Shields such as these may, for example, be produced by means of a powder-injection-molding process. In this case, a plastic material is used as the carrier material. However, plastic resin, possibly in conjunction with reinforcing materials, can also be used as the carrier material in this case. This makes it possible to produce extremely lightweight, geometrically complex structures with the desired mechanical, magnetic, and thermal characteristics.

Another advantageous embodiment of the invention provides for the shield to be formed from modules which are three-dimensionally shaped. Modules such as these may, for example, be used as a coating or as covers for existing pressure plates and for example may form rectangular or honeycomb modules, which can be inserted between the supports for the stator winding without major effort. In this way, existing generators can easily be retrofitted, with additional losses effectively being reduced.

One advantageous development provides for the shield to be inserted into recesses in the end pressure plates. This on the one hand has a desirable influence on the magnetic field while, however, also improves the mechanical strength of the shielding module on the pressure plate. Furthermore, the shielding module can surround the pressure plate towards the air gap.

The insertion into the pressure plate can be achieved, for example, by screwing in, gluing, casting-in or pressing-in, in which case parts of the pressure plate can project at points or on lines, for anchoring.

As an alternative to the arrangement in recesses in the end pressure plates, the shield may be arranged radially above, radially below or axially in front of the pressure plates.

In principle, a shield according to the invention can be used for all areas of the stator core and of the generator casing which are in contact with the magnetic lines of force of the end field. Furthermore, the shielding modules can be arranged between the supports or above and below the supports of the stator winding, or may rest on the supports at the side, thus sucking the magnetic flux away from the uncovered pressure plate areas under the supports.

A further advantageous embodiment of the shield according to the invention provides for the shield to be produced as a layer structure composed of composite particles and highly conductive material. The highly conductive material may preferably be copper, with the composite particles being sintered or electrochemically applied to the copper on the side where the field enters, that is to say on the stator-winding side.

Finally, one advantageous embodiment of the invention provides for the pressure plates to be replaced completely by a shield composed of composite particles. This is possible by virtue of the excellent strength characteristics of the composite particles together with possible reinforcement (for example by glass fibers being mixed in) and the use of appropriate three-dimensional finite element design processes. This makes it possible to achieve additional savings in production and installation, and to increase the rating of the three-phase generator.

An exemplary method according to the invention for production of a shield for components on the stator of a three-phase generator, with the shield being in the form of complex, if necessary curved, components or modules, has the following steps:

production of a negative mold of the component or module;

introduction of soft-magnetic composite particles into the mold and compression at ambient temperature;

heat-treatment of the pressed components or modules composed of soft-magnetic composite particles at about 500° C.

Furthermore, the shield can also be extrusion-coated or encapsulated with a frame composed of fiber-reinforced plastic or a frame composed of non-magnetic steel.

The composite particles cannot be sintered, because of the thin electrical insulation layer. A combined pressing and hardening process, with the latter being carried out at a temperature of up to 500° C., is therefore proposed for creation of a complex geometry. Undesirable material stresses remain in the material when used at significantly lower temperatures, and these can lead to undesirable greater hysteresis losses. There is no need for costly reworking when pressing to a permanent shape is carried out in this way. Alternatively, however, a block can also be pressed, with the respective three-dimensional structure being milled from solid. This is particularly advantageous when it is not intended to produce relatively large quantities of identical parts and it is therefore not worthwhile creating a negative mold.

### BRIEF DESCRIPTION OF THE DRAWINGS

Further advantages of the invention will be described in more detail in the following text, together with the description of one preferred exemplary embodiment of the invention, and with reference to the figures, in which:

FIG. 1 shows a detail of a three-phase generator with a shield according to the invention, in the form of a section view;

FIG. 1a shows a modified embodiment of a three-phase generator with a shield according to the invention, in the form of a section view;

FIG. 2 shows a partial view in the direction of the arrow A from FIG. 1;

FIG. 3 shows a detail of a perspective view of a plate shield;

FIG. 4 shows a schematic section through a plate as shown in FIG. 3; and

FIG. 5 shows a detail of a three-phase generator according to the prior art, in the form of a section view.

The illustrations in the attached figures are schematic, by way of example. Identical or similar components in the figures are provided with the same reference symbols. Furthermore, only those elements which are significant for understanding of the invention are illustrated.

### DETAILED DESCRIPTION OF EXEMPLARY EMBODIMENTS

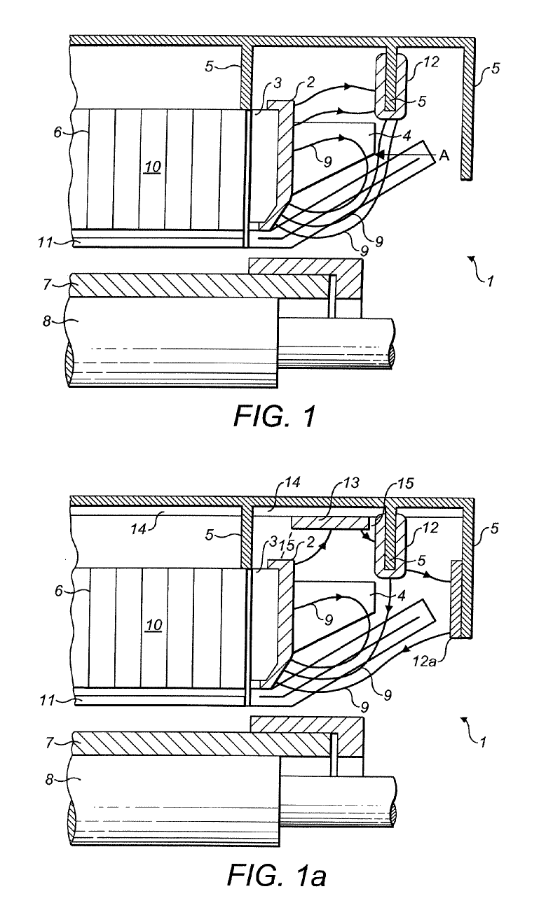

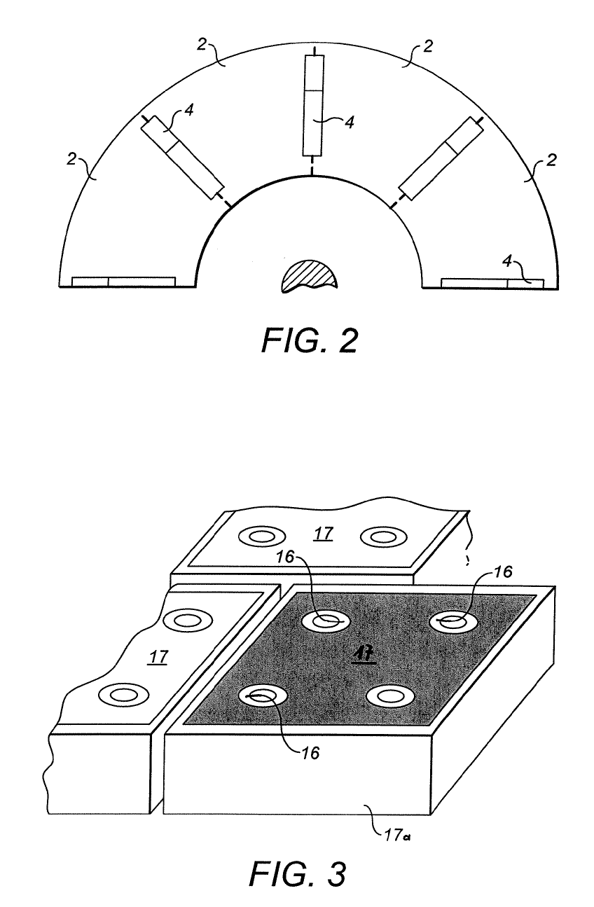

FIG. 1 shows a detail of a schematically illustrated three-phase generator with one advantageous embodiment of a shield according to the invention, in the form of a section view. FIG. 2 shows a partial view in the direction of the arrow A in FIG. 1.

The three-phase generator 1, which is illustrated schematically in FIG. 1, has a rotor body 8 in which rotor windings 7 are arranged in recesses, which are not illustrated. Furthermore, the three-phase generator 1 has a stator 10, which has a stator core 6. The rotor is arranged such that it can rotate concentrically in the stator core 6 and is terminated at the end, at the level of the end winding, by metallic pressure plates 3, for example composed of steel or aluminum. The stator core 6 is held in a casing 5.

The stator core 6 is fitted with a stator winding 11. The free ends of the stator winding 11, the so-called end windings, are held by supports 4, which are themselves mounted on the pressure plate 3. As can be seen from the illustration in FIG. 2, eight supports 4 are provided and they are each arranged offset through 45° over the annular surface. The shields 2 according to the invention extend over the pressure plates 3 between the supports 4. The shields 2 are in this case in the form of three-dimensional modules, which clasp the pressure plates 3 at the top and bottom, as can be seen from the section illustration in FIG. 1. The shields 2 are pressed from an isotropic soft-magnetic composite material, in the present exemplary embodiment from Somaloy 500, and are then heat-treated at 500° C. There is no need for reworking of the shielding modules with this type of production. The shield 2 has an average wall thickness of about 5 to 10 cm.

In general, the shields 2 can be inserted into recesses in the end pressure plates 3, or can be arranged radially above, radially below or axially in front of the end pressure plates 3.

FIG. 1a shows a modified embodiment of a three-phase generator 1 with shields 2, 12 and 13 according to the invention, in the form of a section view. In comparison to the embodiment shown in FIG. 1, this variant has additional longitudinal ribs 14, and additional lateral ribs, which are not illustrated, in order to stiffen the casing 5. In this case, in addition to the shield 2, a rib shield 12 is also provided in the end area of the stator, on a transverse rib, as well as a cylindrical casing shield 13.

The magnetic field 9 can be adjusted to a limited extent by means of the intermediate spaces 15 which are provided between the individual shields 2, 12, 12a, 13.

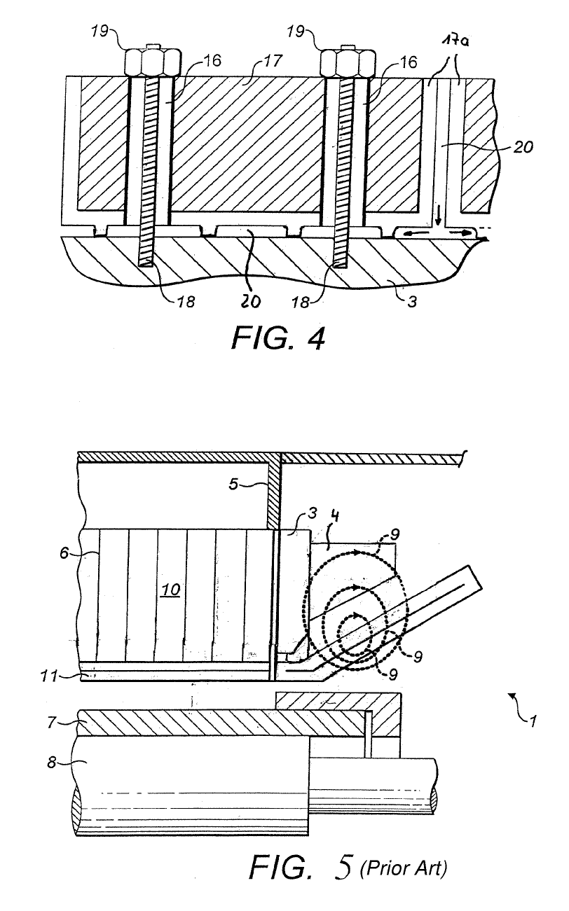

FIGS. 3 and 4 show a plate configuration of the shield in the form of a detail perspective view, and a schematic section through the composite plate 17. The composite plates 17 are in this case essentially rectangular and, in the present exemplary embodiment, have a frame 17a and four vertical sleeves 16 for folding threaded pins 18. The frame 17a, the sleeves 16 and the threaded pins 18 are in this case produced from fiber-reinforced plastic and/or from non-magnetic steel.

The threaded pins 18 are passed through the sleeves 16 and are screwed into the pressure plates 3. The composite plates 17 are then attached to the pressure plates 3 by means of nuts 19, which are screwed onto the threaded pins 18 which project from the sleeves 16. In consequence, no mechanical forces act on the sensitive composite plates 17. A tiled structure such as this is illustrated in the form of a section view in FIG. 4.

Air gaps 20 are provided between the composite plates 17. The plate structure with magnetic tangential and radial air gaps 20 can also be used to control the magnitude of the flux that is sucked up. A cooling medium can also flow through the gaps, if required (arrows in FIG. 4).

The shield shown in FIGS. 3 and 4 with rectangular plates can alternatively also be formed by honeycomb modules. The honeycomb modules are then likewise produced from composite material and can be attached to the pressure plates in a similar manner.

The illustrated advantageous embodiment of a shield according to the invention results in a magnetic field that is better than that in the case of the prior art in the area of the pressure plates, as is indicated by the illustrated magnetic lines of force 9. The additional losses are considerably reduced, and a build up of heat is prevented by the flux suction that is achieved by the avoidance of eddy currents in the pressure plates and in the casing wall.

### LIST OF REFERENCE SYMBOLS

1 Three-phase generator

2 Shield

3 Pressure plate

4 Support

5 Casing

6 Stator core

7 Rotor winding

8 Rotor body

9 Magnetic line of force

10 Stator

11 Stator winding

12 Shield

12a Shield

13 Cylindrical casing shield

14 Longitudinal rib

15 Intermediate space

16 Sleeve

17 Composite plate

17a Frame

18 Threaded pin

19 Nut

20 Air gap

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A shield for components on a stator, which has a stator core with a stator winding, of a three-phase generator having a casing, the stator core optionally including at least one pressure plate arranged at an end on the stator core, the shield comprising a magnetically permeable composite material of low electrical conductivity.

2. The shield as claimed in claim 1, further comprising:
the at least one pressure plate and the casing, the at least one pressure plate and the casing each including areas close to the winding and remote from the winding, and
the shield is fit to said areas close to the winding of the at least one pressure plate, of the casing, or of both.

3. The shield as claimed in claim 1, wherein the composite material comprises magnetically permeable composite particles which are surrounded by an insulating layer.

4. The shield as claimed in claim 3, wherein the insulating layer of the composite particles has a thickness of about 20 μm to about 40 μm.

5. The shield as claimed in claim 1, further comprising:
a carrier material in which the composite particles are held.

6. The shield as claimed in claim 1, comprising three-dimensionally shaped modules forming the shield.

7. The shield as claimed in claim 6, comprising tiles or a honeycomb forming the shield.

8. The shield as claimed in claim 1, further comprising:
the at least one pressure plate, which includes recesses in the at least one pressure plate;
wherein the shield is arranged in said recesses, or arranged radially above the at least one pressure plate, or arranged radially below the at least one pressure plate, or arranged axially in front of the at least one pressure plate.

9. The shield as claimed in claim 1, comprising a layer structure composed of composite particles and highly conductive material, with a layer of composite particles facing the stator winding, forming the shield.

10. The shield as claimed in claim 9, wherein the highly conductive material is copper, to which copper the composite particles are sintered or electrochemically attached.

11. The shield as claimed in claim 1, wherein the at least one pressure plate is completely replaced by a shield composed of composite particles.

12. A method for production of a shield for casing composites, casing bushings, or both, on a stator of a three-phase generator, the shields formed as complex components or modules, the method comprising:
producing a negative mold of the component or module;
introducing soft-magnetic composite particles into the mold and compressing said particles at ambient temperature; and
heat-treating the pressed components or modules composed of soft-magnetic composite particles at about 500° C.

13. The method as claimed in claim 12, further comprising:
extrusion coating or encapsulating a shield with a frame composed of fiber-reinforced plastic or of non-magnetic steel.

14. The shield as claimed in claim 1, wherein the shield consists essentially of a magnetically permeable composite material of low electrical conductivity.

15. A generator comprising:
a casing;
a stator in said casing having a stator core with a stator winding and a stator core end;
at least one pressure plate arranged at the stator core end; and
a shield according to claim 1 positioned to reduce eddy current losses at the at least one pressure plate.

16. A generator as claimed in claim 15, wherein the generator is a three-phase generator.
